(19) United States
(12) Patent Application Publication
(10) Pub. No.: US 2011/0168501 A1
(43) Pub. Date: Jul. 14, 2011

(54) WHEEL CHOCK WITH SOLAR-POWERED LIGHTS

(76) Inventor: Stephen K. Henry, Boulder, CO (US)

(21) Appl. No.: 12/684,418

(22) Filed: Jan. 8, 2010

(51) Int. Cl. B60T 3/00; B60Q 1/26

(52) U.S. Cl. 188/32; 362/541; 362/183

(57) ABSTRACT

A wheel chock assembly includes a self-contained, solar-powered lighting module held in a recess on an external surface of the wheel chock. The protective panel can be used to cover the lighting module. The lighting module includes photovoltaic cells for generating electricity from sunlight, light-emitting diodes (LEDs), and an energy-storage device (e.g., batteries or capacitors) for storing excess electrical energy to power the LEDs at night.

### BACKGROUND OF THE INVENTION

### Field of the Invention

The present invention relates generally to the field of wheel chocks. More specifically, the present invention discloses a wheel chock equipped with solar-powered lights.

### Statement of the Problem

Wheel chocks have been used for many years to restrain unwanted movement of wheeled vehicles when parked. Wheel chocks have also been used in the field of aviation to prevent the wheels of parked aircraft from rolling. Aviation wheel chocks are commonly used at both civilian airports and military air installations, including aircraft carriers.

A problem arises if an aviation wheel chock is accidently left on a runway or other areas where it might be hit by ground-support equipment or aircraft. This is a particular risk at night when equipment operators or aircraft pilots might be less able to see a wheel chock in their path. A collision with a wheel chock can damage an aircraft or cause a loss of control. This is also a problem with regard to other types of wheel chocks if they are left where they might be hit by other types of vehicles.

Therefore, a need exists for a wheel chock that minimizes the risk of collision with aircraft or other vehicles. More specifically, the wheel chock should be highly visible, particularly at night. In addition, the wheel chock's solar-powered lights should be self-contained and rugged, so as not to be easily damaged in normal use as a wheel chock.

### Solution to the Problem

The present invention addresses this problem by providing a wheel chock with an integral solar-powered lighting module that is embedded in a recess in the wheel chock. This configuration largely protects the lighting module from damage when the wheel chock is used under normal conditions in the field. In addition, modular construction of the lighting module make the assembly more rugged, and simplifies fabrication and repair.

### SUMMARY OF THE INVENTION

This invention provides a wheel chock assembly that includes a self-contained, solar-powered lighting module held in a recess on an external surface of the wheel chock. The protective panel can be used to cover the lighting module. The lighting module includes photovoltaic cells for generating electricity from sunlight, light-emitting diodes (LEDs), and an energy-storage device (e.g., batteries or capacitors) for storing excess electrical energy to power the LEDs at night.

These and other advantages, features, and objects of the present invention will be more readily understood in view of the following detailed description and the drawings.

### BRIEF DESCRIPTION OF THE DRAWINGS

The present invention can be more readily understood in conjunction with the accompanying drawings, in which:

FIG. 1 is an exploded perspective view of an embodiment of the present invention showing assembly of the solar-powered lighting module 20 and protective cover panel 30 into the recess 13 of a wheel chock 10.

FIG. 2 is a perspective view corresponding to FIG. 1 showing the completed assembly.

FIG. 3 is an exploded perspective view of an embodiment of the present invention with a wheel chock 10 having a triangular cross-section.

FIG. 4 is a cut-away perspective view of an embodiment with a wheel chock 10 having a bottom void 16 and a flange 18 for initial installation of the solar-powered lighting module 20. A portion of the wheel chock 10 has been cut away to show the walls of the void 16, flange 18 and recess 13 in cross-section.

FIG. 5 is a cut-away perspective view corresponding to FIG. 4 after the void 16 has been filled with material 19 to hold the solar-powered lighting module 20 in place against the flange 18 of the recess 13.

FIG. 6 is a schematic circuit diagram for the solar-powered lighting module.

### DETAILED DESCRIPTION OF THE INVENTION

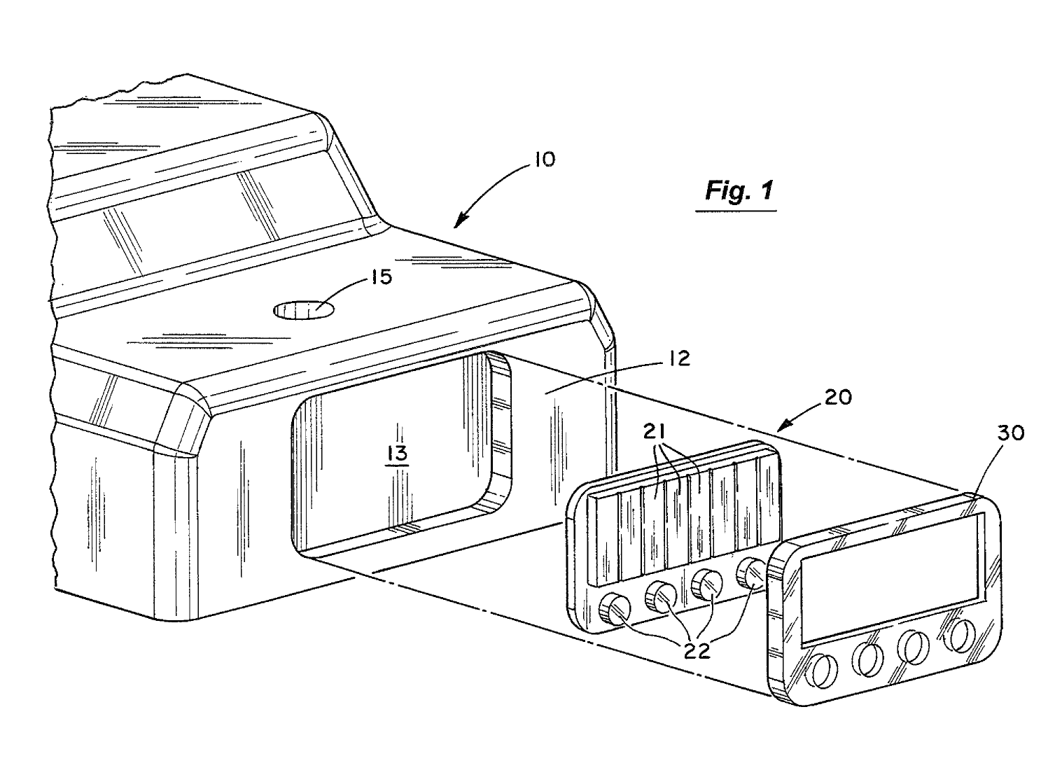

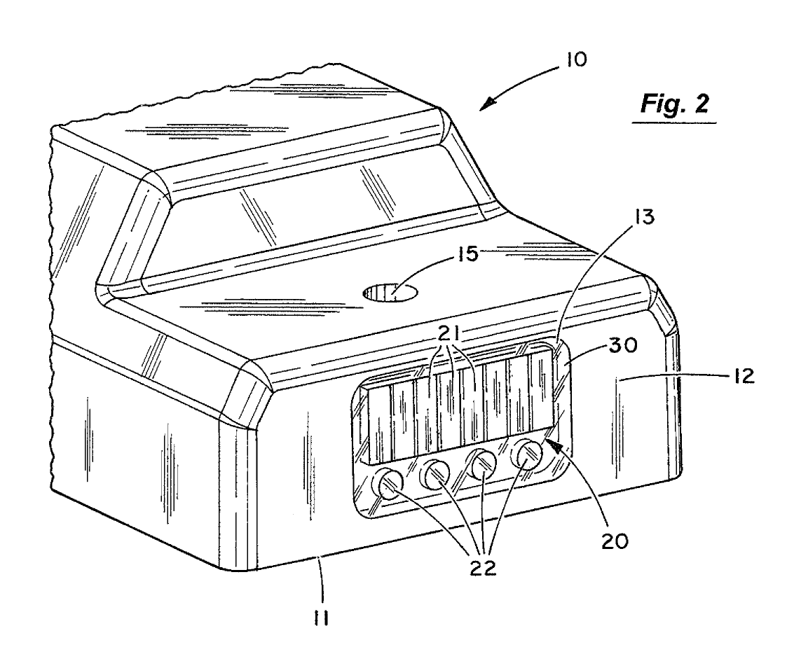

Turning to FIG. 1, an exploded perspective view of an embodiment of the present invention is depicted showing assembly of the solar-powered lighting module 20 and protective cover panel 30 into the recess 13 of a wheel chock 10. FIG. 2 is a perspective view corresponding to FIG. 1 showing the completed assembly. The wheel chock 10 can have any of a variety of conventional shapes. For example, the wheel chock 10 can have a base surface 11 and a number of exposed top surfaces designed to contact vehicle wheels.

The embodiment depicted in FIGS. 1 and 2 employs a recess 13 in an end surface 12 of the wheel chock 10 to reduce the risk of the lighting module 20 being damaged by a vehicle wheel. The lighting module 20 is embedded in this recess 13, and then covered with a protective cover panel 30. For example, these components can be bonded into the recess 13 with an adhesive or attached by screws. Alternatively, a protective panel can be formed over the lighting module 20 by molding a layer of clear polymer over the lighting module 20 after it has been installed in the recess 13. The protective cover panel 30 or the end surface 12 of the wheel chock 10 can also be equipped with resilient bumpers to help protect the lighting module 20.

The exposed face of the lighting module 20 is somewhat recessed into the recess 13 after assembly and includes a number of photovoltaic cells 21 for generating electricity to power the lighting module 20 when exposed to sunlight, as well as a number of light-emitting diodes 22 (LEDs). The wheel chock 10 can also include one or more holes 15 for ropes to assist in moving the wheel chock 10.

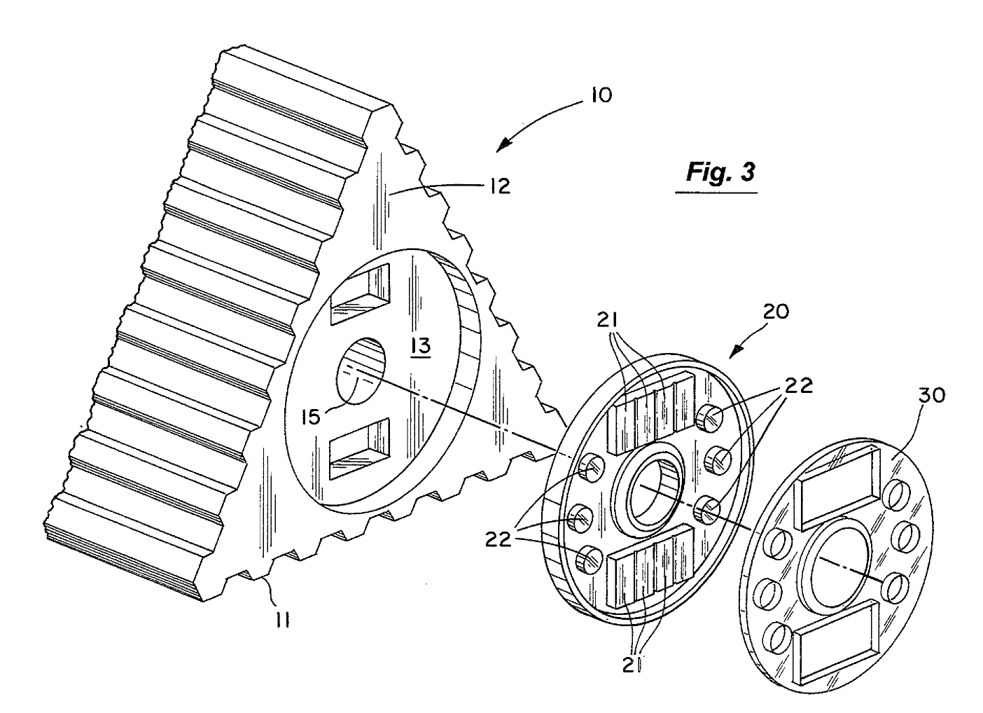

FIG. 3 is an exploded perspective view of an embodiment of the present invention with a wheel chock 10 having a triangular cross-section. Here again, the lighting module 20 and cover panel 30 are mounted in a recess 13 in an end surface 12 of the wheel chock 10. A rope hole 15 passes through the middle of lighting module 20 and cover panel 30.

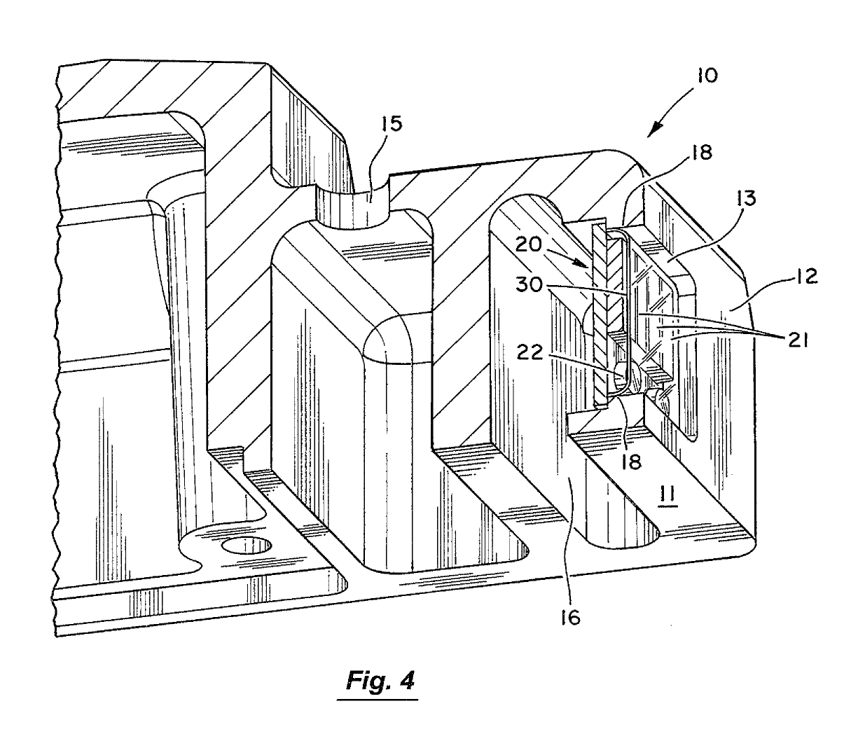

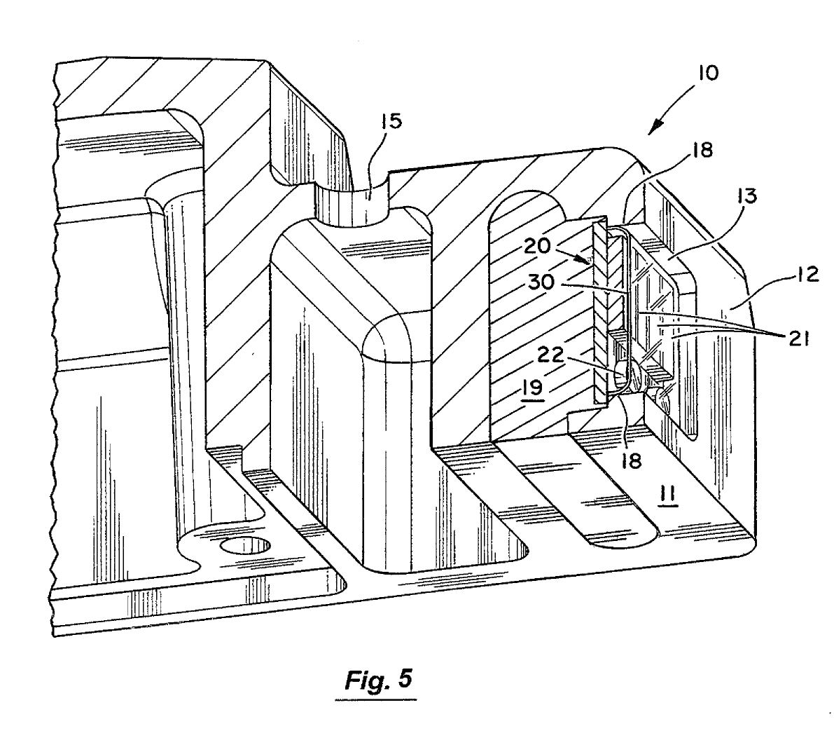

FIG. 4 is a cut-away perspective view of an embodiment with a wheel chock 10 having a bottom void 16 and a retaining flange 18 for initial installation of the solar-powered lighting module 20. A portion of the wheel chock 10 has been cut away to show the walls of the void 16, retaining flange 18 and recess 13 in cross-section. Note that the bottom void 16 extends upward from the bottom surface 11 of the wheel chock 10 and is in communication with the rear of the recess 13 extending inward from the end surface 12 of the wheel chock 10. In this embodiment, the lighting module 20 is initially inserted through the bottom void 16 until it abuts the back of the retaining flange 18 at the rear of the recess 13. The exposed face of the lighting module 20 is thus mounted in the recess 13 with its exposed face visible through the recess 13. The bottom void is then filled with a material 19, as shown in FIG. 5, to hold the lighting module 20 in place against the retaining flange 18.

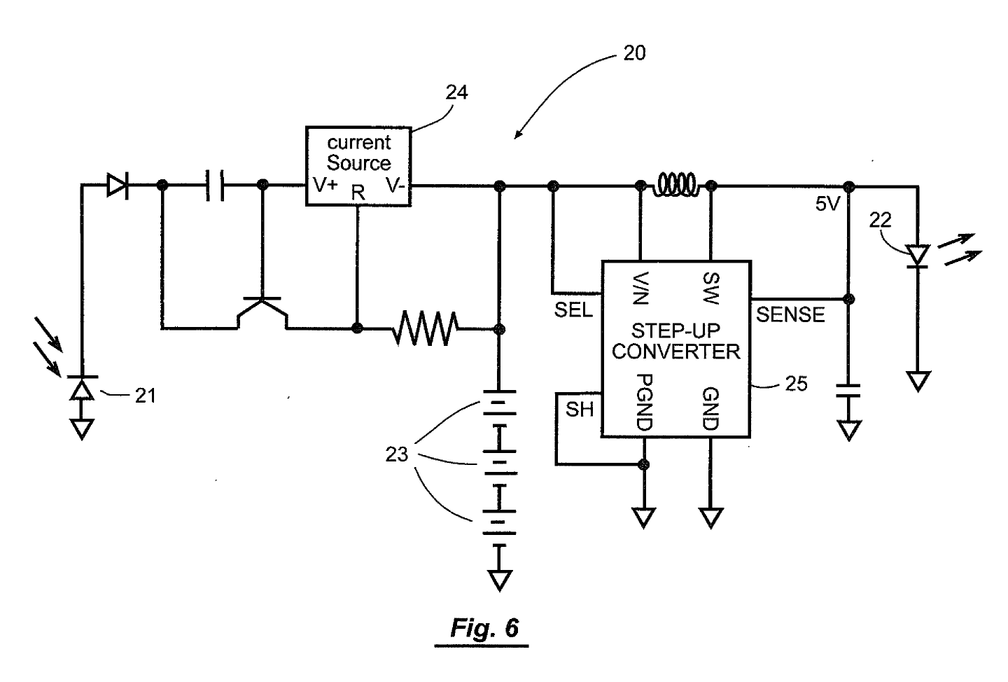

FIG. 6 is a schematic circuit diagram showing one example of the solar-powered lighting module 20. Solar energy is converted to electricity by a number of photovoltaic cells 21. This current is regulated by a current source 24 and used to charge a number of rechargeable batteries 23 or capacitors. A step-up converter 25 regulates the output voltage of the batteries 23 at a constant 5V. A number of LEDs 22 are powered by the batteries 23. Electrical power stored in the batteries 23 is capable of powering the LEDs 22 for a period of time up to 24 hours. In the preferred embodiment, the LEDs flash to maximize their visibility. It should be understood that other types of lights and/or energy storage devices could be readily substituted.

The above disclosure sets forth a number of embodiments of the present invention described in detail with respect to the accompanying drawings. Those skilled in this art will appreciate that various changes, modifications, other structural arrangements, and other embodiments could be practiced under the teachings of the present invention without departing from the scope of this invention as set forth in the following claims.

I claim:

1. A wheel chock assembly comprising:
a wheel chock having at least one external surface with a recess; and
a solar-powered lighting module held in the recess of the wheel chock.

2. The wheel chock assembly of claim 1 wherein the lighting module has an exposed face that is recessed in the recess in the wheel chock.

3. The wheel chock assembly of claim 1 further comprising a protective panel covering the lighting module.

4. The wheel chock assembly of claim 1 wherein the wheel chock further comprises an end surface and wherein the recess is in the end surface of the wheel chock.

5. The wheel chock assembly of claim 1 wherein the lighting module further comprises light-emitting diodes.

6. The wheel chock assembly of claim 1 wherein lighting module further comprises energy storage means for storing electric energy to power the lighting module for a period of time in the absence of sunlight.

7. A wheel chock assembly comprising:
a wheel chock having at least one external surface with a recess; and
a solar-powered lighting module held in the recess of the wheel chock, said lighting module having:
(a) an exposed face visible in the recess of the wheel chock;
(b) photovoltaic cells on the exposed face of the lighting module generating electricity when exposed to sunlight;
(d) an electrical energy storage device storing electricity generated by the photovoltaic cells; and
(c) light-emitting diodes (LEDs) on the exposed face of the lighting module, said light-emitting diodes being powered by the electrical energy storage device to emit light during periods of darkness.

8. The wheel chock assembly of claim 7 further comprising a flange extending about the periphery of the recess to retain the solar-powered lighting module in the recess.

9. The wheel chock assembly of claim 7 wherein the electrical energy storage device comprises a battery.

10. The wheel chock assembly of claim 7 wherein the electrical energy storage devices comprises a capacitor.

11. The wheel chock assembly of claim 7 further comprising a protective panel covering the exposed face of the lighting module.

12. The wheel chock assembly of claim 7 wherein the wheel chock further comprises an end surface and wherein the recess is in the end surface of the wheel chock.

13. A wheel chock assembly comprising:
a solar-powered lighting module having an exposed face with photovoltaic cells and lights; and
a wheel chock having:
(a) a first external surface with a recess extending into the wheel chock;
(b) a second external surface having a void extending into the wheel chock in communication with the recess, whereby the lighting module is insertable through the void into the recess; and
(c) a retaining flange in the recess for retaining the lighting module after insertion of the lighting module through the void, with the exposed face of the lighting module being mounted in the recess.

14. The wheel chock assembly of claim 13 further comprising filling material filling the void behind the lighting module after installation of the lighting module.

15. The wheel chock assembly of claim 13 further comprising a protective panel covering the exposed face of the lighting module.
